(19) United States
(12) Patent Application Publication
(10) Pub. No.: US 2007/0094496 A1
(43) Pub. Date: Apr. 26, 2007

(54) System and method for kernel-level pestware management

(76) Inventor: Michael Burtscher, Longmont, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/257,609

(22) Filed: Oct. 25, 2005

(51) Int. Cl. H04L 9/00

(52) U.S. Cl. 713/164

(57) ABSTRACT

Systems and methods for managing pestware on a protected computer are described. One embodiment is configured to reroute a call to create a process to a kernel-level process monitor, identify a file associated with the process and analyze the file so as to determine whether the file is a pestware file. If the file is a pestware file, then the process is prevented from being created. In variations, the kernel-level process monitor is a kernel-mode driver adapted to communicate with a pestware application residing in a user-level of memory.

### RELATED APPLICATIONS

The present application is related to the following commonly owned and assigned applications: application Ser. No. 10/956,578, Attorney Docket No. WEBR-002/00US, entitled System and Method for Monitoring Network Communications for Pestware and application Ser. No. 10/956,574, Attorney Docket No. WEBR-005/00US, entitled System and Method for Pestware Detection and Removal, each of which is incorporated by reference in their entirety.

### FIELD OF THE INVENTION

The present invention relates to computer system management. In particular, but not by way of limitation, the present invention relates to systems and methods for controlling pestware or malware.

### BACKGROUND OF THE INVENTION

Personal computers and business computers are continually attacked by trojans, spyware, and adware, collectively referred to as “malware” or “pestware.” These types of programs generally act to gather information about a person or organization-often without the person or organization's knowledge. Some pestware is highly malicious. Other pestware is non-malicious but may cause issues with privacy or system performance. And yet other pestware is actually beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

Software is available to detect and remove some pestware, but many variations of pestware are difficult to detect with typical techniques. For example, pestware running in memory of a computer is often difficult to detect because it is disguised in such a way that it appears to be a legitimate process that is dependent from a trusted application (e.g., a word processor application). In other cases, pestware is obfuscated with encryption techniques so that a pestware file stored on a system hard drive may not be readily recognizable as a file that has spawned a pestware process. In yet other instances, pestware is known to be polymorphic in nature so as to change its code, data, size and/or its starting address in memory.

Additionally, existing processes (e.g., pestware or non-pestware processes) may spawn a new pestware processes without being identified as a pestware process. One technique for tracking and preventing new pestware processes from being spawned is to inject code into existing processes. When an existing process attempts to create a new process, the injected code can check the process to be started and raise a flag if the existing process is attempting to create a new pestware process. Problematically, injecting code into a desirable process simply may not work because pestware may circumvent or neutralize the injected code. Moreover, the injected code may cause the desirable process to crash or cause other inadvertent problems. As a consequence, this code injection technique is often abandoned at the risk of additional pestware being spawned. Accordingly, current software is not always able to identify and remove pestware in a convenient manner and will most certainly not be satisfactory in the future.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment, the invention may be characterized as a method for managing pestware on a protected computer, the method comprising rerouting a call to create a process to a kernel-level process monitor, identifying a file associated with the process, analyzing the file so as to determine whether the file is a pestware file; and preventing, in response to the file being identified as a pestware file, the process from being created.

In another embodiment the invention may be characterized as a system of managing pestware, the system comprising a pestware detection module configured to analyze a file of a protected computer to determine whether the file is associated with pestware, a kernel-level process monitor configured to notify the pestware detection module of an attempt to create a process that is associated with the file and prevent the process from being created in response to the pestware detection module identifying the file as being associated with pestware.

In yet another embodiment, the invention may be characterized as a computer readable medium encoded with instructions for managing pestware on a protected computer, the instructions comprising instructions for generating a kernel-level process monitor at the protected computer and altering an operating system of the protected computer so as to reroute a call to create a process from the operating system to the kernel-level process monitor. In this embodiment, the kernel-level process monitor is configured to prevent the process from being created in response to a file corresponding to the process being identified as a pestware file.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 is a block diagram depicting a protected computer in accordance with one implementation of the present invention;

FIG. 2 is a block diagram depicting a protected computer in accordance with another implementation of the present invention;

FIG. 3 is a block diagram depicting a protected computer in accordance with yet another implementation of the present invention; and

FIG. 4 is a flowchart of one method for managing pestware in accordance with several embodiments of the present invention.

### DETAILED DESCRIPTION

According to several embodiments, the present invention monitors activities on a protected computer so as to reduce or prevent pestware from being activated without the undesirable effects of injecting code into running processes. In many variations for example, when a first process attempts to spawn a pestware process, the API call utilized by the first process to create the pestware process is intercepted before it is carried out by an operating system of the protected computer. In this way, the pestware process is prevented from being initiated until an assessment is made as to whether it is desirable to have the process running on the protected computer.

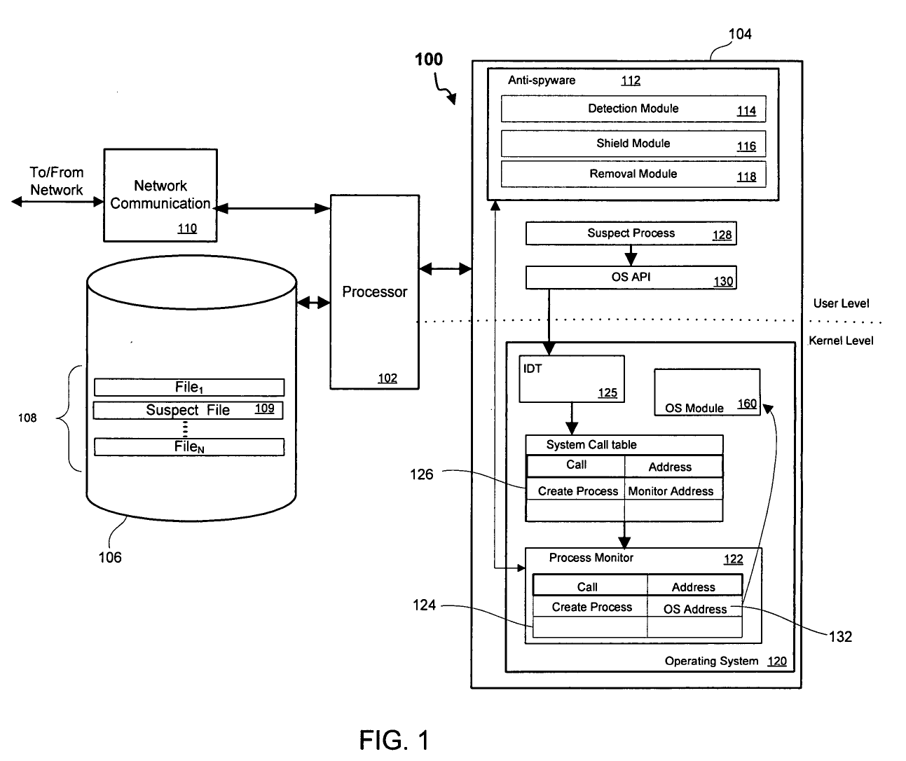

Referring first to FIG. 1, shown is a block diagram 100 of a protected computer/system in accordance with one implementation of the present invention. The term “protected computer” is used herein to refer to any type of computer system, including personal computers, handheld computers, servers, firewalls, etc. This implementation includes a processor 102 coupled to memory 104 (e.g., random access memory (RAM)), a file storage device 106, and network communication 110.

As shown, the storage device 106 provides storage for a collection of N files 108, which includes a suspect file 109 (i.e., a suspected pestware file). The storage device 106 is described herein in several implementations as hard disk drive for convenience, but this is certainly not required, and one of ordinary skill in the art will recognize that other storage media may be utilized without departing from the scope of the present invention. In addition, one of ordinary skill in the art will recognize that the storage device 106, which is depicted for convenience as a single storage device, may be realized by multiple (e.g., distributed) storage devices.

As depicted, the memory 104 in this embodiment is shown with an anti-spyware application 112 in a user level portion of the memory 104 and an operating system 120 is shown in a kernel level portion of the memory 104. One of ordinary skill in the art will appreciate the memory 104 is shown divided merely to depict a functional division in the level of code executed from the memory 104 and not a physical division. In addition, a suspect process 128 and an operating system application programming interface (API) 130 (e.g., Win32) are also depicted as being executed from the user-level portion of memory 104.

In the exemplary embodiment, the suspect process 128 is a process running in the memory 104 that may not be associated with any suspicious activities other than attempting to initiate the execution of the suspect file 109. As discussed further herein, the suspect file 109 is a file that may not be recognized as a pestware file until the suspect process 128 attempts to execute it.

As shown, the anti-spyware application 112 includes a detection module 114, a shield module 116 and a removal module 118, which are implemented in software and are executed from the memory 104 by the processor 102. The software 112 can be configured to operate on personal computers (e.g., handheld, notebook or desktop), servers or any device capable of processing instructions embodied in executable code. Moreover, one of ordinary skill in the art will recognize that alternative embodiments, which implement one or more components in hardware, are well within the scope of the present invention. In addition, it should be recognized that the anti-spyware application 112 in alternative embodiments may be implemented in kernel mode.

The operating system 120 in this embodiment includes a process monitor 122 that is in communication with the anti-spyware application 112. Also depicted in the operating system 120 is an interrupt descriptor table 125 and a modified call table 126. The modified call table 126 in this embodiment is a call table of the operating system 120 that has been modified so that the memory address that is ordinarily associated with creating a process has been replaced with the address of the process monitor 122. In this way, when the suspect process 128 initiates a create-process-call (e.g., via the OS API 130), the create-process-call is mapped to the process monitor 122 instead of being mapped to an operating system service 160 that is responsible for creating processes.

As shown, the process monitor 122 in this embodiment includes a generated call table 124 that replicates a call table ordinarily utilized by the operating system 120. The generated call table maps a create-process-call with a starting address of operating system code that is responsible for creating processes. A create-process-call that is routed to the process monitor 122 from the modified table 126, however, is not routed directly to the generated call table 124. Instead, as discussed further herein, the process monitor 122, in connection with the anti-spyware application 112, first determines whether it is desirable to carry out the create-process-call before the create-process-call is allowed to be mapped to the operating system service 160 that is responsible for creating processes.

In several embodiments, the process monitor 122 is realized by a kernel mode driver that may be loaded during a boot sequence for the protected computer or anytime later.

In the present embodiment, the operating system 120 is not limited to any particular type of operating system and may be operating systems provided by Microsoft Corp. under the trade name WINDOWS (e.g., WINDOWS 2000, WINDOWS XP, and WINDOWS NT). Additionally, the operating system may be an open source operating system such operating systems distributed under the LINUX trade name. For convenience, however, embodiments of the present invention are generally described herein with relation to WINDOWS-based systems. Those of skill in the art can easily adapt these implementations for other types of operating systems or computer systems.

In several embodiments, the detection module 114 is generally responsible for detecting pestware or pestware activity on the protected computer 100 based upon the information received from the N files 108. In one embodiment for example, the detection module 114 compares a representation of known pestware files (e.g., a cyclical redundancy code (CRC) of a portion of the pestware file) with a representation (e.g., CRC) of a portion of each of the N files 108. In one variation, only 500 Bytes of information are retrieved from each of the N files 124 and a CRC of the 500 Bytes of information retrieved from each file is compared with the known pestware definitions. If the 500 Bytes of retrieved information indicates the file is a potential pestware file, then a more thorough analysis (e.g., an analysis of the entire file) is conducted. In this way, the comparison of each file with definitions of pestware files is expedited.

Pestware and pestware activity can also be detected by the shield module 116, which generally runs in the background on the computer system. Shields can generally be divided into two categories: those that use definitions to identify known pestware and those that look for behavior common to pestware. This combination of shield types acts to prevent known pestware and unknown pestware from running or being installed on a protected computer.

In many cases, the detection and shield modules (114 and 116) detect pestware by matching files on the protected computer with definitions of pestware, which are collected from a variety of sources. For example, a host computer, protected computers and other systems can crawl the Web to actively identify pestware. These systems often download programs and search for exploits. The operation of these exploits can then be monitored and used to create pestware definitions. Various techniques for detecting pestware are disclosed in the above-identified and related application entitled: System and Method for Monitoring Network Communications for Pestware.

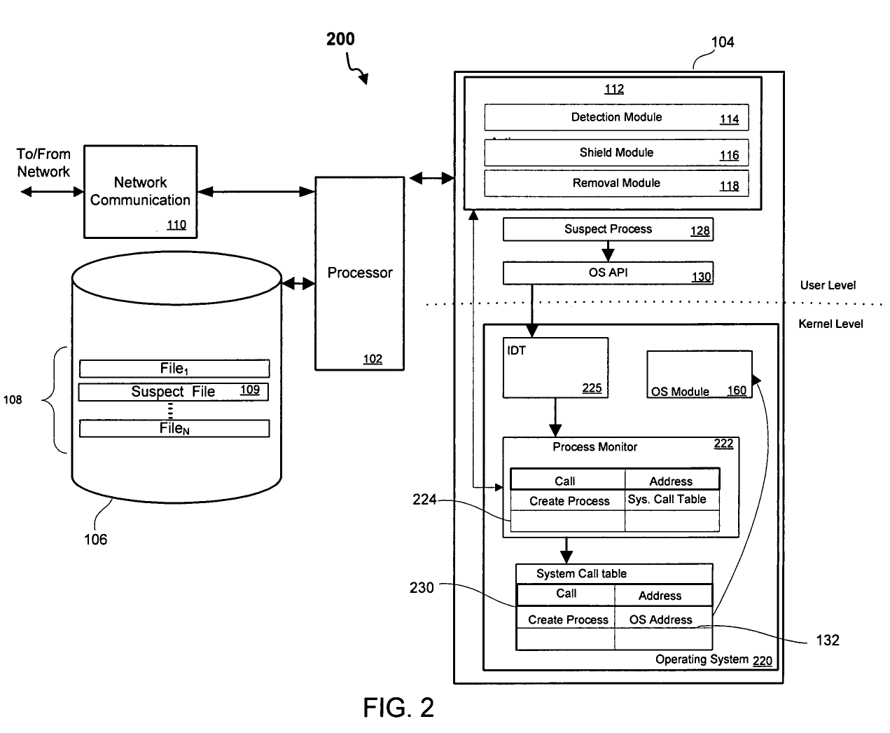

Referring next to FIG. 2, shown is a block diagram 200 of a protected computer/system in accordance with another embodiment of the present invention. As shown, the protected computer/system depicted in FIG. 2 includes the same components as the protected computer/system depicted in FIG. 1, except the operating system 220 of the protected computer/system of FIG. 2 has been altered in a different manner than the operating system 120 depicted in FIG. 1.

In particular, the call table 230 depicted in FIG. 2, has not been modified, and instead, an interrupt descriptor table 225 has been modified so that a memory address that is ordinarily associated with a system call table 230 has been replaced with the address of a process monitor 222. In this way, when the suspect process 128 initiates a create-process-call (e.g., via the OS API 130), the create-process-call is mapped to the process monitor 122 instead of being mapped to the system call table 230.

As shown, the process monitor 222 in this embodiment is configured to communicate with the anti-spyware application 112 so that it may first determine whether it is desirable to carry out the create-process-call before the create-process-call is allowed to be mapped to either the system call table 230 or the operating system service 160 that is responsible for creating processes.

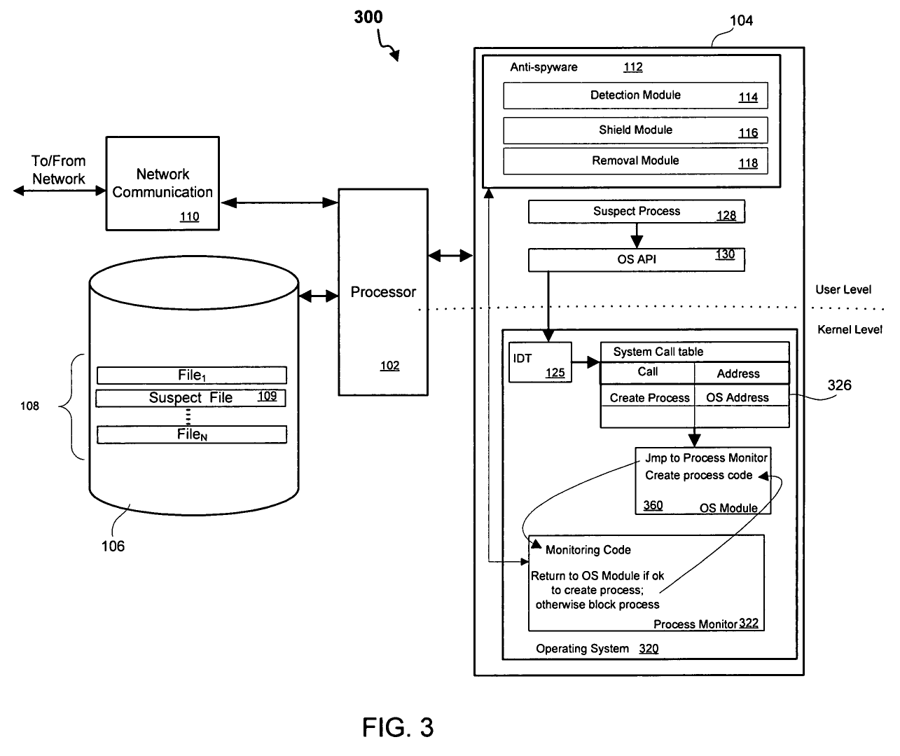

Referring next to FIG. 3, shown is a block diagram 300 of a protected computer/system in accordance with yet another embodiment of the present invention. As shown, the protected computer/system depicted in FIG. 3 includes the same components as the protected computer/system depicted in FIG. 1, except the operating system 320 of the protected computer/system of FIG. 3 has been altered in a different manner than the operating system 120 depicted in FIG. 1.

Specifically, instead of any modifications being made to either a interrupt descriptor table 125 or system call table 326, the operating system service 360 that is responsible for creating a process in response to a create-process-call has been modified so that a jump instruction to the process monitor 322 is executed before the operating system module 360 creates the process.

As shown, the process monitor 322 in this embodiment, like the process monitors 122, 222 depicted in FIGS. 1 and 2, is configured to communicate with the anti-spyware application 112 so that may first determine whether it is desirable to allow a process to be created. Specifically, if a file (e.g., the suspect file 109) associated with the process to be created is identified as a pestware file by the detection module 114, the process monitor 322 prevents the operating system service 360 from creating a process.

If, however, the file associated with the process to be created is not identified as a pestware file by the detection module 114, the process monitor 322 initiates a jump instruction that allows code associated with the operating system service 360 to create the process. One of ordinary skill in the art will appreciate that if the alteration of the operating system service 360 (e.g., insertion of a jump instruction) causes instructions associated with creating a process to be deleted, the deleted code may stored and executed by the process monitor 322 before jumping back to the operating system service 360.

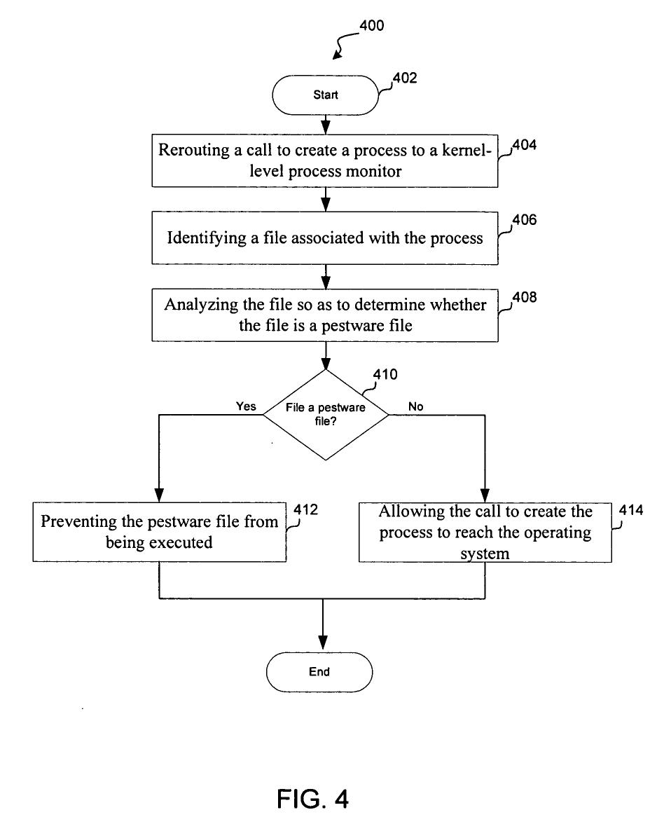

Referring next to FIG. 4, shown is a flowchart 400 depicting steps carried out by the protected computers of FIGS. 1, 2 and 3 to manage pestware. In operation, when the suspect process 128 does attempt to launch the suspect file 109, the suspect process 128 sends a create-process-call that is intended to initiate execution of the suspect file 109 file. In some embodiments, the suspect process 128 sends the create-process-call to the OS API 130, which then sends a corresponding create-process-call to the operating system 120.

Instead of being immediately carried out by the operating system 120, however, the create-process-call is rerouted to the process monitor 122, 222, 322 (Block 404). In the exemplary embodiment depicted in FIG. 1, the modified table 126 is generated by supplanting an address in a call table of the operating system 120, which pointed to the operating system service 160 for creating new processes, with the address of the process monitor 122.

In the embodiment depicted in FIG. 2, the interrupt descriptor table 225 is modified so that a create-process-call is routed to the process monitor 222, and in the embodiment depicted in FIG. 3, the operating system service 360 associated with creating a process is modified so that during execution, a jump instruction to the process monitor 322 is carried out. In this way, instead of the operating system service 160, 360 associated with creating a process being carried out, the process monitor 122, 222, 322 receives the create-process-call.

As shown in FIG. 4, once the create-process-call is rerouted to the process monitor 122, 222, 322, a file associated with the suspect process 128 is identified (Block 406). In the exemplary embodiments of FIGS. 1, 2 and 3 the suspect file 109 is associated with the suspect process 128 by virtue of being the file that the suspect process 128 is programmed to initiate (Block 414).

Once a file (e.g., the suspect file 109) is identified as being associated with the suspect process 128, the file is analyzed so as to determine whether the file is a pestware file (Block 408). In the exemplary embodiment, the detection module 114 compares at least a portion of the suspect file 109 with pestware definitions to determine whether the suspect file 109 is a pestware file. As depicted in FIG. 4, if the suspect file 109 is identified as a pestware file (Block 410), the anti-spyware application 112 sends a notification to the process monitor 122, 222, 322 to prompt the process monitor 122, 222, 322 to prevent the pestware file 109 from being executed (Block 412).

If the suspect file 109 is not identified as a pestware file (Block 410), then the process monitor 122, 222, 322 routes the create-process-call to the operating system service 160, 360 where code resides to initiate the execution of the suspect file 109 (Block 414).

In conclusion, the present invention provides, among other things, a system and method for managing pestware. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for managing pestware on a protected computer comprising:
rerouting a call to create a process to a kernel-level process monitor;
identifying a file associated with the process;
analyzing the file so as to determine whether the file is a pestware file; and
preventing, in response to the file being identified as a pestware file, the process from being created.

2. The method of claim 1, wherein the rerouting includes altering a table in an operating system of the protected computer so as to direct the call to create the process to the kernel-level process monitor.

3. The method of claim 1, wherein the rerouting includes altering code in the operating system of the protected computer so as to direct the call to create the process to the kernel-level process monitor.

4. The method of claim 3, wherein the altering the code includes adding a jump instruction to code of the operating system, wherein the jump instruction reroutes the call to create the process to the kernel-level process monitor.

5. The method of claim 1 including:
initiating, in response to the analyzing determining that the file is not a pestware file, execution of code to create the process.

6. The method of claim 1, wherein the analyzing includes comparing a least a portion of the file with pestware definitions.

7. The method of claim 1, wherein the kernel-level process monitor is a kernel mode driver.

8. A system of managing pestware, comprising:
a pestware detection module configured to analyze a file of a protected computer so as to determine whether the file is associated with pestware; and
a kernel-level process monitor configured to
notify the pestware detection module of an attempt to create a process that is associated with the file; and
prevent the process from being created in response to the pestware detection module identifying the file as being associated with pestware.

9. The system of claim 8, wherein the pestware detection module resides in a user-level operating space of the protected computer.

10. The system of claim 8, wherein the kernel-level process monitor is configured to initiate code to create the process in response to the pestware detection module determining that the file is not a pestware file.

11. The system of claim 8, wherein the kernel-level process monitor is a kernel mode driver.

12. A computer readable medium encoded with instructions for managing pestware on a protected computer, the instructions comprising instructions for:
generating a kernel-level process monitor at the protected computer; and
altering an operating system of the protected computer so as to reroute a call to create a process from the operating system to the kernel-level process monitor;
wherein the kernel-level process monitor is configured to prevent the process from being created in response to a file corresponding to the process being identified as a pestware file.

13. The computer readable medium of claim 12 including instructions for initiating, in response to the analyzing determining that the file is not a pestware file, execution of code to create the process.

14. The computer readable medium of claim 13 including instructions for comparing a least a portion of the file with pestware definitions.

15. The computer readable medium of claim 12 wherein the instructions for generating a kernel-level process monitor include instructions for generating the kernel-level process monitor as a kernel mode driver.

16. The computer readable medium of claim 12 wherein the instructions for altering include instructions for altering a table of the operating system so as to reroute the call to create the process from the operating system to the kernel-level process monitor.

17. The computer readable medium of claim 16 wherein the instructions for altering the table include instructions for altering a system call table.

18. The computer readable medium of claim 12 wherein the instructions for altering the table include instructions for altering an interrupt descriptor table.

19. The computer readable medium of claim 12 wherein the instructions for altering include instructions for altering code of the operating system so as to reroute the call to create a process to the kernel-level process monitor.
